(19) United States
(12) Patent Application Publication
(10) Pub. No.: US 2026/0255288 A1
(43) Pub. Date: Aug. 27, 2026

(54) TRANSMISSION SYNCHRONIZATION METHOD AND APPARATUS, AND STORAGE MEDIUM

(71) Applicant: Beijing Xiaomi Mobile Software Co., Ltd., Beijing (CN)

(72) Inventors: Xiaofei LIU, Beijing (CN); Yumin WU, Beijing (CN)

(73) Assignee: Beijing Xiaomi Mobile Software Co., Ltd., Beijing (CN)

(21) Appl. No.: 18/856,263

(22) PCT Filed: Apr. 12, 2022
(86) PCT No.: PCT/CN2022/086433

§ 371 Date: Oct. 11, 2024

(51) Int. Cl. H04W 56/00; H04W 4/06; H04W 72/232

(52) U.S. Cl. CPC H04W 56/0015; H04W 4/06; H04W 72/232

(57) ABSTRACT

A transmission synchronization method, including: sending synchronization control information to at least one first network-side node, where the synchronization control information is configured to control the at least one first network-side node to perform physical downlink control channel (PDCCH) transmission synchronization, and a PDCCH corresponds to a multicast broadcast service (MBS).

### CROSS-REFERENCE TO RELATED APPLICATION

The present application is a U.S. National Stage of International Application No. PCT/CN2022/086433, filed on Apr. 12, 2022, the contents of all of which are incorporated herein by reference in their entireties for all purposes.

### BACKGROUND OF THE INVENTION

Currently, only Multicast Broadcast Service (MBS) synchronization, i.e., MBS synchronization for a Single-Frequency Network (SFN), in an intra-Distributed Unit (intra-DU) scenario is supported in Release 17 (R17).

### SUMMARY OF THE INVENTION

The present disclosure relates to the field of communications, in particular to a transmission synchronization method and apparatus, and a storage medium.

According to a first aspect of the present disclosure, there is provided a transmission synchronization method. The transmission synchronization method is performed by a second network-side node and includes: sending synchronization control information to at least one first network-side node, where the synchronization control information is configured to control the at least one first network-side node to perform physical downlink control channel (PDCCH) transmission synchronization, and the PDCCH corresponds to a multicast broadcast service (MBS).

According to a second aspect of the present disclosure, there is provided a transmission synchronization method. The service synchronization method is performed by a first network-side node and includes: receiving synchronization control information sent by a second network-side node, where the synchronization control information is configured to control at least one of the first network-side nodes to perform physical downlink control channel (PDCCH) transmission synchronization, and the PDCCH corresponds to a multicast broadcast service (MBS); and performing the PDCCH transmission synchronization based on the synchronization control information.

According to a third aspect of the present disclosure, there is provided a transmission synchronization apparatus. The transmission synchronization apparatus is applied to a second network-side node and includes: a sending module, configured to send synchronization control information to at least one first network-side node, where the synchronization control information is configured to control the at least one first network-side node to perform physical downlink control channel (PDCCH) transmission synchronization, and the PDCCH corresponds to a multicast broadcast service (MBS).

According to a fourth aspect of the present disclosure, there is provided a transmission synchronization apparatus. The transmission synchronization apparatus is applied to a first network-side node and includes: a receiving module, configured to receive synchronization control information sent by a second network-side node, where the synchronization control information is configured to control at least one of the first network-side nodes to perform physical downlink control channel (PDCCH) transmission synchronization, and the PDCCH corresponds to a multicast broadcast service (MBS); and a synchronization module, configured to perform the PDCCH transmission synchronization based on the synchronization control information.

According to a fifth aspect of the present disclosure, there is provided a non-transitory computer-readable storage medium storing a computer program, where the computer program is configured to perform the transmission synchronization method described in any embodiment in the first aspect.

According to a sixth aspect of the present disclosure, there is provided a non-transitory computer-readable storage medium storing a computer program, where the computer program is configured to perform the transmission synchronization method described in any embodiment in the second aspect.

According to a seventh aspect of the present disclosure, there is provided a transmission synchronization apparatus, including: a processor; and a memory configured to store processor-executable instructions; where the processor is configured to execute the processor-executable instructions to implement the steps of the transmission synchronization method described in any embodiment in the first aspect.

According to an eighth aspect of the present disclosure, there is provided a transmission synchronization apparatus, including: a processor; and a memory configured to store processor-executable instructions; where the processor is configured to execute the processor-executable instructions to implement the steps of the transmission synchronization method described in any embodiment in the second aspect.

### BRIEF DESCRIPTION OF DRAWINGS

The drawings are incorporated into the specification and constitute a part of the specification, show embodiments that are consistent with the present disclosure, and are used together with the specification to explain the principles of the present disclosure.

FIG. 1 is a schematic flowchart of a transmission synchronization method according to an example of the disclosure.

FIG. 2 is a schematic flowchart of another transmission synchronization method according to an example of the disclosure.

FIG. 3 is a schematic flowchart of another transmission synchronization method according to an example of the disclosure.

FIG. 4 is a schematic flowchart of another transmission synchronization method according to an example of the disclosure.

FIG. 5 is a block diagram of a transmission synchronization apparatus according to an example of the disclosure.

FIG. 6 is a block diagram of another transmission synchronization apparatus according to an example of the disclosure.

FIG. 7 is a schematic structural diagram of a transmission synchronization apparatus according to an example of the disclosure.

FIG. 8 is a schematic structural diagram of another transmission synchronization apparatus according to an example of the disclosure.

### DETAILED DESCRIPTION OF THE INVENTION

The embodiments will be described in detail, and examples thereof are illustrated in the accompanying drawings. When the following description involves the accompanying drawings, unless otherwise indicated, the same numerals in different accompanying drawings indicate the same or similar elements. The implementations described in the following embodiments do not represent all the implementations consistent with the present disclosure. On the contrary, they are examples of apparatuses and methods consistent with some aspects of the present disclosure, as detailed in the appended claims.

The terms used in the present disclosure are for the purpose of describing particular embodiments and are not intended to limit the present disclosure. The singular forms “a/an”, “said” and “the” used in the present disclosure and the appended claims are intended to include the plural forms as well, unless the context clearly indicates otherwise. It is also to be understood that the term “and/or” as used in the disclosure refers to and includes any and all possible combinations of one or more related listed items.

It is to be understood that, although the terms “first”, “second”, “third”, etc., may be used to describe various information in the present disclosure, the information is not limited to these terms. These terms are used to distinguish information of the same type from each other. For example, “first information” may also be referred to as “second information”. Similarly, “second information” may also be referred to as “first information”, without departing from the scope of the present disclosure. Depending on the context, the word “if” as used in the disclosure may be interpreted as “in the case of ...” or “when ...” or “in response to determining”.

In a 5^{th} Generation Mobile Communication Technology (5G) New Radio (NR) system, an MBS service may be marked with an MBS service ID. The MBS service ID includes at least one of: a Temporary Mobile Group Identity (TMGI), an MBS Session ID or an MBS QOS flow ID.

There are two sending modes for the MBS service.

In a sending mode 1 (multicast sending), a terminal enters a radio resource control-connected state (RRC_CONNECTED) to receive sending configuration information for the MBS service, and then receive the MBS service. A network-side device sends reception configuration information for the MBS service to the terminal through terminal-specific signaling.

In a sending mode 2 (broadcast sending), the terminal may receive the sending configuration information for the MBS service in an IDLE state, an INACTIVE state, or a CONNECTED state, and receive the MBS service. The network-side device sends the reception configuration information for the MBS service to the terminal through system information and MBS control channel (MCCH) information. The system information may be a System Information Block (SIB).

Currently, only Multicast Broadcast Service (MBS) synchronization, i.e., MBS synchronization for a Single-Frequency Network (SFN), in an intra-Distributed Unit (intra-DU) scenario is supported in Release 17 (R17).

Considering that the MBS service is specific to an SFN, only supporting the SFN in the intra-DU scenario limits a number of SFN cell deployments and expected gain of the SFN. In order to solve these technical problems, the present disclosure provides a transmission synchronization method and apparatus, and a storage medium as follows.

The following introduces a transmission synchronization method provided by the present disclosure from the side of a second network-side node.

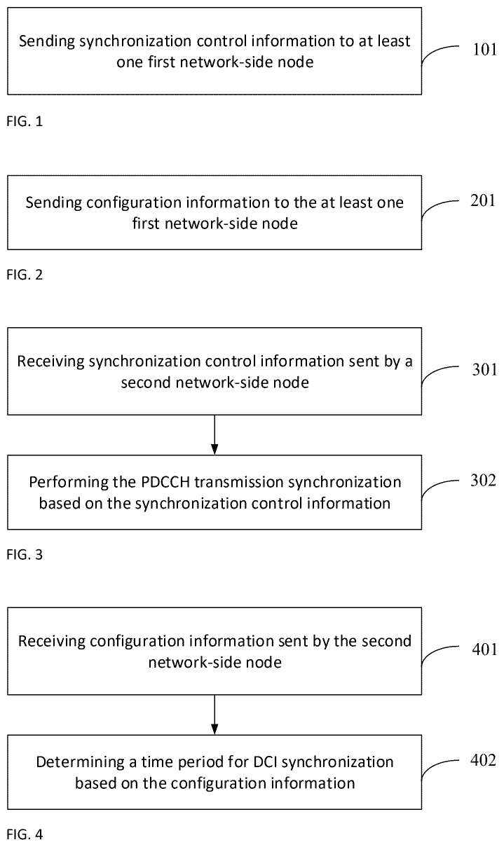

An embodiment of the present disclosure provides a transmission synchronization method. FIG. 1 is a flowchart of a transmission synchronization method according to an embodiment of the disclosure, which may be performed by a second network-side node. The second network-side node may be a base station, a Centralized Unit (CU), a Distributed Unit (DU), or a network-side node (e.g., an MBS master node) independent of the nodes, which will not be limited in the present disclosure. The transmission synchronization method may include step 101.

Step 101 includes sending synchronization control information to at least one first network-side node.

The first network-side node may be a CU or a DU. The synchronization control information is configured to control the at least one first network-side node to perform physical downlink control channel (PDCCH) transmission synchronization, and the PDCCH corresponds to a multicast broadcast service (MBS).

The transmission synchronization method may be applied to an NR communication system or a communication system after the NR communication system.

By controlling at least one first network-side node by the second network-side node, PDCCH transmission synchronization corresponding to the MBS is realized, and thus MBS synchronization under an NR system is realized, wide-area service deployment is supported, an SFN transmission scenario is expanded, cell edge performance and spectrum utilization are improved, and the availability is high.

In some embodiments, the PDCCH transmission synchronization includes at least one of: PDCCH transmission synchronization corresponding to MBS transmission channel (MTCH) transmission; PDCCH transmission synchronization corresponding to MBS control channel (MCCH) transmission; PDCCH transmission synchronization corresponding to MCCH modification notification information; or PDCCH transmission synchronization corresponding to resource scheduling.

The MTCH transmission includes at least one of: MTCH transmission corresponding to a multicast service; or MTCH transmission corresponding to a broadcast service.

The resource scheduling corresponds to any one of the following scheduling modes: carrying resource scheduling information through downlink control information (DCI); and activating or deactivating predetermined resource scheduling information through the DCI.

In some embodiments, the second network-side node may send the synchronization control information to the at least one first network-side node through inter-node signaling, thereby realizing PDCCH transmission synchronization corresponding to the MBS.

The PDCCH transmission synchronization may include at least one of: DCI transmission content synchronization; or DCI transmission resource synchronization.

In an example, the DCI transmission content synchronization includes DCI transmission information synchronization. It is to be noted that the PDCCH uses a same DCI format by default to transmit the DCI.

In an example, in a case that there exists a plurality of candidate DCI formats, the DCI transmission content synchronization includes DCI format synchronization and DCI transmission information synchronization.

In an example, the DCI transmission resources include at least one of: time domain resources, frequency domain resources, space domain resources, coding modes, or numerology. The numerology corresponds to one Subcarrier Spacing (SCS) in a frequency domain.

In an example, the time domain resources include, but are not limited to, at least one of: Searching Space (SS), System Frame Number (SFN), subframe, slot, cycle, or starting position.

The frequency domain resources include, but are not limited to, at least one of: Control Resource Set (CORESET), frequency, bandwidth, point-A, Bandwidth Part (BWP), Cell-ID, or Physical Cell Identifier (PCI).

The space domain resources include, but are not limited to, Transmission Configuration Index (TCI) state, such as Synchronization Signal and PBCH block (SSB) or Channel State Information-Reference Signal (CSI-RS).

The coding modes include, but are not limited to, Radio Network Temporary Identity (RNTI), DCI format, Demodulation Reference Signal (DMRS), scrambling code, etc.

In an example, numerology needs to be synchronized before each PDCCH transmission. In an example, numerology may be synchronized each time BWP configuration information is synchronized. In the described examples, by controlling at least one first network-side node by the second network-side node, PDCCH transmission synchronization corresponding to the MBS is realized, and thus MBS synchronization under an NR system is realized, wide-area service deployment is supported, an SFN transmission scenario is expanded, cell edge performance and spectrum utilization are improved, and the availability is high.

FIG. 2 is a flowchart of a transmission synchronization method according to an example of the disclosure, which may be performed by a second network-side node. The second network-side node may be a base station, a CU, a DU, or a network-side node (e.g., an MBS master node) independent of the nodes. The transmission synchronization method may include step 201.

Step 201 includes sending configuration information to the at least one first network-side node.

The configuration information is configured to configure a time period for DCI synchronization.

In an example, the configuration information is configured to indicate at least one of: performing the DCI synchronization in each scheduling slot; or performing the DCI synchronization in a specified scheduling slot.

In a case that the configuration information is configured to indicate performing the DCI synchronization in a specified scheduling slot, assuming that the first network-side node performs the DCI synchronization in a specified scheduling slot, the first network-side node does not need to perform the DCI synchronization in other specified scheduling slots, and may directly reuse previously synchronized DCI.

It is also to be noted that step 201 may be implemented separately or implemented in combination with step 101. In a case that step 201 is implemented in combination with step 101, the execution order of step 101 and step 201 is not limited in the present disclosure, i.e., step 101 may be executed before step 201 or after step 201, or step 101 and step 201 may be executed at the same time.

In the described examples, the second network-side node may configure a time period for the DCI synchronization for the first network-side node, so that the at least one first network-side node can be controlled to perform PDCCH transmission synchronization corresponding to the MBS. The implementation is simple and the availability is high.

In some examples, considering that performing the DCI synchronization in each scheduling slot may introduce a scheduling delay, in order to save signaling overhead and reduce the delay, the configuration information in the present disclosure may be configured to indicate performing the DCI synchronization in a specified scheduling slot.

In an example, the configuration information is configured to indicate performing the DCI synchronization based on a predefined or pre-configured cycle.

In an example, the configuration information includes one or more bitmaps. That is, the configuration information is configured to indicate performing the DCI synchronization in a specified scheduling slot in each specified cycle. The specified scheduling slot is a scheduling slot indicated by bit that is preset value in at least one of the bitmaps. The preset value may be 1 or 0, which will not be limited in the present disclosure.

For example, the configuration information includes one bitmap of 010101010 with the preset value of 1, the specified scheduling slots are 1^{st}, 3^{rd}, 5^{th}, and 7^{th} scheduling slots, and the first network-side node performs the DCI synchronization in the 1^{st}, 3^{rd}, 5^{th}, and 7^{th} scheduling slots in a specified cycle (e.g., 10 milliseconds). In addition, after performing the DCI synchronization in the 1^{st} scheduling slot, the first network-side node may directly reuse the synchronized DCI in the 3^{rd}, 5^{th}, and 7^{th} scheduling slots.

For another example, the configuration information includes two bitmaps of 010101010 and 110101010 with the preset value of 1, the specified scheduling slots are 0^{th}, 1^{st}, 3^{rd}, 5^{th}, and 7^{th} scheduling slots, and the first network-side node performs the DCI synchronization in the 0^{th}, 1^{st}, 3^{rd}, 5^{th}, and 7^{th} scheduling slots in a specified cycle (e.g., 10 milliseconds). In addition, after performing the DCI synchronization in the 0^{th} scheduling slot, the first network-side node may directly reuse the synchronized DCI in the 1^{st}, 3^{rd}, 5^{th}, and 7^{th} scheduling slots.

In an example, the configuration information is configured to indicate a reference time point or a reference time period. In a case that the configuration information is configured to indicate the reference time point, the first network-side node may perform the DCI synchronization in at least one scheduling slot before or after the reference time point. In a case that the configuration information is configured to indicate the reference time period, the first network-side node may perform the DCI synchronization in at least one scheduling slot within the reference time period. Similarly, in a case that the DCI synchronization is performed in a specified scheduling slot, the first network-side node does not need to perform the DCI synchronization in other specified scheduling slots, and may directly reuse previously synchronized DCI.

The reference time point or the reference time period includes, but is not limited to, an absolute time point or absolute time period, an SFN index, a subframe index, and a slot index.

In an example, in a case that the reference time period is the absolute time period, the first network-side node may perform the DCI synchronization in at least one slot included in the absolute time period. The at least one slot included in the absolute time period may be some or all of the slots included in the absolute time period, which will not be limited in the present disclosure.

In an example, in a case that the reference time period is the SFN index, the first network-side node may perform the DCI synchronization in at least one slot included in at least one system frame corresponding to the SFN index. The at least one system frame corresponding to the SFN index may be some or all of the system frames corresponding to the SFN index, and the at least one slot included in at least one system frame corresponding to the SFN index may be some or all of the slots included in at least one system frame corresponding to the SFN index, which will not be limited in the present disclosure.

In an example, in a case that the reference time period is the subframe index, the first network-side node may perform the DCI synchronization in at least one slot included in at least one subframe corresponding to the subframe index. The at least one subframe corresponding to the subframe index may be some or all of the subframes corresponding to the subframe index, and the at least one slot included in at least one subframe corresponding to the subframe index may be some or all of the slots included in at least one subframe corresponding to the subframe index, which will not be limited in the present disclosure.

In an example, in a case that the reference time period is the slot index, the first network-side node may perform the DCI synchronization in at least one slot corresponding to the slot index. The at least one slot corresponding to the slot index may be some or all of the slots corresponding to the slot index, which will not be limited in the present disclosure.

In the described examples, the second network-side node may configure a time period for the DCI synchronization for the first network-side node, so that the at least one first network-side node can be controlled to perform PDCCH transmission synchronization corresponding to the MBS, signaling resources can be saved, and the delay is reduced.

The following introduces a transmission synchronization method provided by the present disclosure from the side of a first network-side node.

An example of the present disclosure provides a transmission synchronization method. FIG. 3 is a flowchart of a transmission synchronization method according to an example of the disclosure, which may be performed by a first network-side node. The first network-side node may be a CU or a DU. The transmission synchronization method may include steps 301 and 302.

Step 301 includes receiving synchronization control information sent by a second network-side node.

The synchronization control information is configured to control at least one of the first network-side nodes to perform physical downlink control channel (PDCCH) transmission synchronization, and the PDCCH corresponds to a multicast broadcast service (MBS).

Step 302 includes performing the PDCCH transmission synchronization based on the synchronization control information.

The transmission synchronization method may be applied to an NR communication system or a communication system after the NR communication system.

In the described examples, the first network-side node may perform PDCCH transmission synchronization corresponding to the MBS based on the synchronization control information sent by the second network-side node, such that MBS synchronization under an NR system is realized, wide-area service deployment is supported, an SFN transmission scenario is expanded, cell edge performance and spectrum utilization are improved, and the availability is high.

In some examples, the PDCCH transmission synchronization includes at least one of: PDCCH transmission synchronization corresponding to MBS transmission channel (MTCH) transmission; PDCCH transmission synchronization corresponding to MBS control channel (MCCH) transmission; PDCCH transmission synchronization corresponding to MCCH modification notification information; or PDCCH transmission synchronization corresponding to resource scheduling.

The MTCH transmission includes at least one of: MTCH transmission corresponding to a multicast service; or MTCH transmission corresponding to a broadcast service.

The resource scheduling corresponds to any one of the following scheduling modes: carrying resource scheduling information through downlink control information (DCI); and activating or deactivating predetermined resource scheduling information through the DCI.

In some examples, the first network-side node may receive the synchronization control information sent by the second network-side node through inter-node signaling, thereby realizing PDCCH transmission synchronization corresponding to the MBS.

In an example, the PDCCH transmission synchronization includes at least one of: DCI transmission content synchronization; or DCI transmission resource synchronization.

In an example, the DCI transmission content synchronization includes DCI transmission information synchronization. It is to be noted that the PDCCH uses a same DCI format by default to transmit the DCI.

In an example, in a case that there exists a plurality of candidate DCI formats, the DCI transmission content synchronization includes DCI format synchronization and DCI transmission information synchronization.

In an example, the DCI transmission resources include at least one of: time domain resources, frequency domain resources, space domain resources, coding modes, or numerology. The numerology corresponds to one Subcarrier Spacing (SCS) in a frequency domain.

In an example, the time domain resources include, but are not limited to, at least one of: Searching Space (SS), System Frame Number (SFN), subframe, slot, cycle, or starting position.

The frequency domain resources include, but are not limited to, at least one of: Control Resource Set (CORESET), frequency, bandwidth, point-A, Bandwidth Part (BWP), Cell-ID, or Physical Cell Identifier (PCI).

The space domain resources include, but are not limited to, Transmission Configuration Index (TCI) state, such as Synchronization Signal and PBCH block (SSB) or Channel State Information-Reference Signal (CSI-RS).

The coding modes include, but are not limited to, Radio Network Temporary Identity (RNTI), DCI format, Demodulation Reference Signal (DMRS), scrambling code, etc.

In an example, numerology needs to be synchronized before each PDCCH transmission. In an example, numerology may be synchronized each time BWP configuration information is synchronized.

In the described examples, the first network-side node may perform PDCCH transmission synchronization corresponding to the MBS based on the synchronization control information sent by the second network-side node, such that MBS synchronization under an NR system is realized, wide-area service deployment is supported, an SFN transmission scenario is expanded, cell edge performance and spectrum utilization are improved, and the availability is high.

FIG. 4 is a flowchart of a transmission synchronization method according to an example of the disclosure, which may be performed by a first network-side node. The first network-side node may be a base station, a CU or a DU. The transmission synchronization method may include steps 401 and 402.

Step 401 includes receiving configuration information sent by the second network-side node.

The configuration information is configured to configure a time period for DCI synchronization.

In an example, the configuration information is configured to indicate at least one of: performing the DCI synchronization in each scheduling slot; or performing the DCI synchronization in a specified scheduling slot.

Step 402 includes determining a time period for DCI synchronization based on the configuration information.

In a case that the configuration information is configured to indicate performing the DCI synchronization in a specified scheduling slot, assuming that the first network-side node performs the DCI synchronization in a specified scheduling slot, the first network-side node does not need to perform the DCI synchronization in other specified scheduling slots, and the first network-side node may directly reuse previously synchronized DCI.

The steps 401 to 402 may be implemented separately or implemented in combination with the steps 301 to 302. Furthermore, the execution order may be adjusted as needed, which will not be limited in the present disclosure.

In the described examples, the first network-side node may determine a time period for DCI synchronization based on the configuration information sent by the second network-side node, so that at least one of the first network-side nodes can be controlled to perform PDCCH transmission synchronization corresponding to the MBS. The implementation is simple and the availability is high.

In some examples, considering that performing the DCI synchronization in each scheduling slot may introduce a scheduling delay, in order to save signaling overhead and reduce the delay, the configuration information in the present disclosure may be configured to indicate performing the DCI synchronization in a specified scheduling slot.

In an example, the configuration information is configured to indicate performing the DCI synchronization based on a predefined or pre-configured cycle.

In an example, the configuration information includes one or more bitmaps. That is, the configuration information is configured to indicate performing the DCI synchronization in a specified scheduling slot in each specified cycle. The specified scheduling slot is a scheduling slot indicated by bit that is preset value in at least one of the bitmaps. The preset value may be 1 or 0, which will not be limited in the present disclosure.

For example, the configuration information includes one bitmap of 010101010 with the preset value of 1, the specified scheduling slots are 1^{st}, 3^{rd}, 5^{th}, and 7^{th} scheduling slots, and the first network-side node performs the DCI synchronization in the 1^{st}, 3^{rd}, 5^{th}, and 7^{th} scheduling slots in a specified cycle (e.g., 10 milliseconds). In addition, after performing the DCI synchronization in the 1^{st} scheduling slot, the first network-side node may directly reuse the synchronized DCI in the 3^{rd}, 5^{th}, and 7^{th} scheduling slots.

For another example, the configuration information includes two bitmaps of 010101010 and 110101010 with the preset value of 1, the specified scheduling slots are 0^{th}, 1^{st}, 3^{rd}, 5^{th}, and 7^{th} scheduling slots, and the first network-side node performs the DCI synchronization in the 0^{th}, 1^{st}, 3^{rd}, 5^{th}, and 7^{th} scheduling slots in a specified cycle (e.g., 10 milliseconds). In addition, after performing the DCI synchronization in the 0^{th} scheduling slot, the first network-side node may directly reuse the synchronized DCI in the 1^{st}, 3^{rd}, 5^{th} and 7^{th} scheduling slots.

In an example, the configuration information is configured to indicate a reference time point or a reference time period.

In a case that the configuration information is configured to indicate the reference time point, the first network-side node may perform the DCI synchronization in at least one scheduling slot before or after the reference time point.

In a case that the configuration information is configured to indicate the reference time period, the first network-side node may perform the DCI synchronization in at least one scheduling slot within the reference time period. Similarly, in a case that the DCI synchronization is performed in a specified scheduling slot (generally, a first specified scheduling slot in the scheduling cycle), the first network-side node does not need to perform the DCI synchronization in other specified scheduling slots, and may directly reuse previously synchronized DCI.

The reference time point or the reference time period includes, but is not limited to, an absolute time point or absolute time period, an SFN index, a subframe index, and a slot index.

In an example, in a case that the reference time period is the absolute time period, the first network-side node may perform the DCI synchronization in at least one slot included in the absolute time period. The at least one slot included in the absolute time period may be some or all of the slots included in the absolute time period, which will not be limited in the present disclosure.

In an example, in a case that the reference time period is the SFN index, the first network-side node may perform the DCI synchronization in at least one slot included in at least one system frame corresponding to the SFN index, and the at least one system frame corresponding to the SFN index may be some or all of the system frames corresponding to the SFN index. The at least one slot included in at least one system frame corresponding to the SFN index may be some or all of the slots included in at least one system frame corresponding to the SFN index, which will not be limited in the present disclosure.

In an example, in a case that the reference time period is the subframe index, the first network-side node may perform the DCI synchronization in at least one slot included in at least one subframe corresponding to the subframe index. The at least one subframe corresponding to the subframe index may be some or all of the subframes corresponding to the subframe index, and the at least one slot included in at least one subframe corresponding to the subframe index may be some or all of the slots included in at least one subframe corresponding to the subframe index, which will not be limited in the present disclosure.

In an example, in a case that the reference time period is the slot index, the first network-side node may perform the DCI synchronization in at least one slot corresponding to the slot index. The at least one slot corresponding to the slot index may be some or all of the slots corresponding to the slot index, which will not be limited in the present disclosure.

In the described examples, a time period for the DCI synchronization may be configured based on the configuration information sent by the second network-side node, so that at least one of the first network-side node can be controlled to perform PDCCH transmission synchronization corresponding to the MBS, signaling resources can be saved, and the delay is reduced.

Corresponding to the examples of foregoing application function implementation method, the present disclosure further provides examples of an application function implementation apparatus.

Referring to FIG. 5, FIG. 5 is a block diagram of a transmission synchronization apparatus according to an example of the disclosure. The transmission synchronization apparatus 500 is applied to a second network-side node and includes: a sending module 501, configured to send synchronization control information to at least one first network-side node, where the synchronization control information is configured to control the at least one first network-side node to perform physical downlink control channel (PDCCH) transmission synchronization, and the PDCCH corresponds to a multicast broadcast service (MBS).

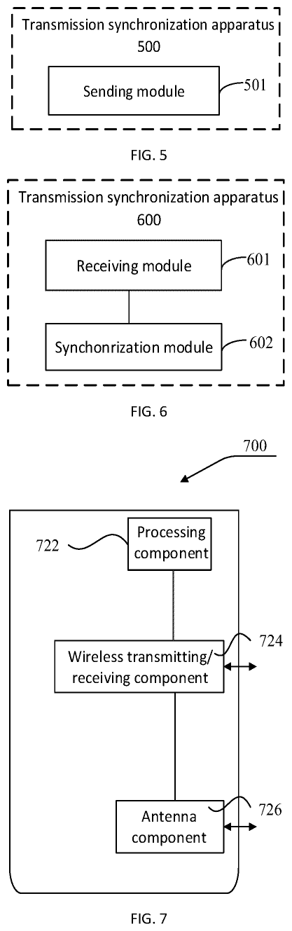

The description of the PDCCH transmission synchronization has been described in detail in the examples and will not be repeated here. Referring to FIG. 6, FIG. 6 is a block diagram of a transmission synchronization apparatus according to an example of the disclosure. The transmission synchronization apparatus 600 is applied to a first network-side node and includes: a receiving module 601 and a synchronization module 602. The receiving module 601 is configured to receive synchronization control information sent by a second network-side node, where the synchronization control information is configured to control at least one of the first network-side nodes to perform physical downlink control channel (PDCCH) transmission synchronization, and the PDCCH corresponds to a multicast broadcast service (MBS). The synchronization module 602 is configured to perform the PDCCH transmission synchronization based on the synchronization control information.

The description of the PDCCH transmission synchronization has been described in detail in the examples and will not be repeated here.

For the apparatus examples, since they basically correspond to the method examples, related parts may be referred to the part of the description of the method examples. The apparatus examples described are illustrative, where the units described as separate components may or may not be physically separated. The components displayed as units may or may not be physical units, i.e., may be located in one place, or may also be distributed on a plurality of network units. Some or all of the modules can be selected according to actual needs to achieve the object of the present disclosure. Those of ordinary skill in the art can understand and implement the present disclosure, without paying any creative work.

The present disclosure further provides a non-transitory computer-readable storage medium storing a computer program, where the computer program is configured to perform any one of the transmission synchronization methods performed by the second network-side node.

The present disclosure further provides a non-transitory computer-readable storage medium storing a computer program, where the computer program is configured to perform any one of the transmission synchronization methods performed by the first network-side node.

The present disclosure further provides a transmission synchronization apparatus, including: a processor; and a memory configured to store processor-executable instructions. Where the processor is configured to perform the steps of any one of the transmission synchronization methods performed by the second network-side node.

As shown in FIG. 7, FIG. 7 is a schematic structural diagram of a transmission synchronization apparatus 700 according to an example of the disclosure. The transmission synchronization apparatus 700 may be provided as a second network-side node. Referring to FIG. 7, the transmission synchronization apparatus 700 includes a processing component 722, a wireless transmitting/receiving component 724, an antenna component 726, and a signal processing portion (not shown) specific to a wireless interface. The processing component 722 may further include at least one processor (not shown).

One of the processors in the processing component 722 may be configured to perform any one of the transmission synchronization methods performed by the second network-side node.

The present disclosure further provides a transmission synchronization apparatus, which includes: a processor; and a memory configured to store processor-executable instructions. Where the processor is configured to perform any one of the transmission synchronization methods performed by the first network-side node.

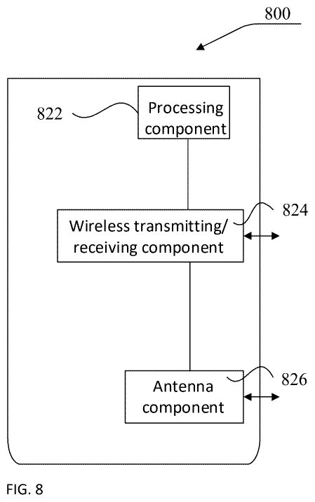

As shown in FIG. 8, FIG. 8 is a schematic structural diagram of a transmission synchronization apparatus 800 according to an example of the disclosure. The transmission synchronization apparatus 800 may be provided as a first network-side node. Referring to FIG. 8, the transmission synchronization apparatus 800 includes a processing component 822, a wireless transmitting/receiving component 824, an antenna component 826, and a signal processing portion (not shown) specific to a wireless interface. The processing component 822 may further include at least one processor (not shown).

One of the processors in the processing component 822 may be configured to perform any one of the transmission synchronization methods performed by the first network-side node.

Other examples of the present disclosure will be apparent to those skilled in the art from consideration of the specification and practice the present disclosure. The present disclosure is intended to cover any variations, uses, or adaptations of the present disclosure, following the general principles thereof and including common knowledge or commonly used technical measures in the technical field which are not disclosed in the disclosure. The specification and examples are to be considered as illustrative, and the true scope and spirit of the present disclosure are indicated by the following claims.

It will be appreciated that the present disclosure is not limited to the exact construction that has been described and illustrated in the accompanying drawings, and that various modifications and changes can be made without departing from the scope thereof. The scope of the present disclosure is limited by the appended claims.

1. A transmission synchronization method, performed by a second network-side node and comprising:
sending synchronization control information to at least one first network-side node, wherein
the synchronization control information is configured to control the at least one first network-side node to perform physical downlink control channel (PDCCH) transmission synchronization, and
the PDCCH corresponds to a multicast broadcast service (MBS).

2. The method according to claim 1, wherein the PDCCH transmission synchronization comprises at least one of:
the PDCCH transmission synchronization corresponding to an MBS transmission channel (MTCH) transmission;,
the PDCCH transmission synchronization corresponding to an MBS control channel (MCCH) transmission;,
the PDCCH transmission synchronization corresponding to an MCCH modification notification information;, or
the PDCCH transmission synchronization corresponding to resource scheduling.

3. The method according to claim 2, wherein the MTCH transmission comprises at least one of:
the MTCH transmission corresponding to a multicast service;, or
the MTCH transmission corresponding to a broadcast service.

4. The method according to claim 2, wherein the resource scheduling corresponds to any of the following scheduling modes:
carrying resource scheduling information through downlink control information (DCI), or
activating or deactivating predetermined resource scheduling information through the DCI.

5. (canceled)

6. The method according to claim 51, wherein the PDCCH transmission synchronization comprises at least one of:
downlink control information (DCI) transmission content synchronization, or
DCI transmission resource synchronization.

7. The method according to claim 6, wherein
the DCI transmission content synchronization comprises DCI transmission information synchronization;, or
the DCI transmission content synchronization comprises DCI format synchronization and DCI transmission information synchronization.

8. The method according to claim 6, wherein the DCI transmission resources comprise at least one of:
time domain resources, frequency domain resources, space domain resources, coding modes, or numerology.

9. The method according to claim 4, further comprising:
sending configuration information to the at least one first network-side node, wherein the configuration information is configured to configure a time period for DCI synchronization.

10. The method according to claim 9, wherein the configuration information is configured to indicate at least one of:
performing the DCI synchronization in each scheduling slot;, or
performing the DCI synchronization in a specified scheduling slot.

11. A transmission synchronization method, performed by a first network-side node and comprising:
receiving synchronization control information sent by a second network-side node,
wherein the synchronization control information is configured to control at least one of the first network-side nodes to perform physical downlink control channel (PDCCH) transmission synchronization, and the PDCCH corresponds to a multicast broadcast service (MBS); and
performing the PDCCH transmission synchronization based on the synchronization control information.

12. The method according to claim 11, wherein the PDCCH transmission synchronization comprises at least one of:
the PDCCH transmission synchronization corresponding to an MBS transmission channel (MTCH) transmission,
the PDCCH transmission synchronization corresponding to an MBS control channel (MCCH) transmission,
the PDCCH transmission synchronization corresponding to an MCCH modification notification information, or
the PDCCH transmission synchronization corresponding to resource scheduling.

13. The method according to claim 12, wherein the MTCH transmission comprises at least one of:
the MTCH transmission corresponding to a multicast service;, or
the MTCH transmission corresponding to a broadcast service.

14. The method according to claim 12, wherein the resource scheduling corresponds to any of the following scheduling modes:
carrying resource scheduling information through downlink control information (DCI), or
activating or deactivating predetermined resource scheduling information through the DCI.

15. (canceled)

16. The method according to claim 11, wherein the PDCCH transmission synchronization comprises at least one of:
downlink control information (DCI) transmission content synchronization;, or DCI transmission resource synchronization.

17. The method according to claim 16, wherein
the DCI transmission content synchronization comprises DCI transmission information synchronization, or
the DCI transmission content synchronization comprises DCI format synchronization and DCI transmission information synchronization.

18. The method according to claim 16, wherein the DCI transmission resources comprise at least one of:
time domain resources, frequency domain resources, space domain resources, coding modes, or numerology.

19. The method according to claim 14, further comprising:
receiving configuration information sent by the second network-side node; and
determining a time period for DCI synchronization based on the configuration information.

20. The method according to claim 19, wherein the configuration information is configured to indicate at least one of:
performing the DCI synchronization in each scheduling slot;, or
performing the DCI synchronization in a specified scheduling slot.

21-24. (canceled)

25. A transmission synchronization apparatus, comprising:
a processor; and
a memory configured to store processor-executable instructions;,
wherein the processor is configured to execute the processor-executable instructions to:
send synchronization control information to at least one first network-side node,
wherein the synchronization control information is configured to control the at least one first network-side node to perform physical downlink control channel (PDCCH) transmission synchronization, and
wherein the PDCCH corresponds to a multicast broadcast service (MBS).

26. A transmission synchronization apparatus, comprising:
a processor; and
a memory configured to store processor-executable instructions;
wherein the processor is configured to execute the processor-executable instructions to implement the transmission synchronization method according to claim 11.
